(19) United States
(12) Patent Application Publication
(10) Pub. No.: US 2020/0001252 A1
(43) Pub. Date: Jan. 2, 2020

(54) MICRO BUBBLE DEVICE, SYSTEM AND METHODS RELATED THERETO

(71) Applicant: Oxygen Systems, LLC, Aurora, CO (US)

(72) Inventor: Ron Stevens, Aurora, CO (US)

(21) Appl. No.: 16/565,314

(22) Filed: Sep. 9, 2019

Related U.S. Application Data
(63) Continuation of application No. 15/146,689, filed on May 4, 2016, now abandoned.
(60) Provisional application No. 62/156,642, filed on May 4, 2015.

(51) Int. Cl. B01F 5/04

(52) U.S. Cl. CPC B01F 5/0413; B05B 7/24

(57) ABSTRACT

A device for enhanced generation of microbubbles in a more efficient manner is provided. The device is smaller, quieter, and more energy-efficient than prior microbubble-generating devices, and is suitable for use with liquid dispensing devices such as hydrotherapy jets, shower heads, liquid nozzles, and bathtub faucets. Methods of use of the enhanced microbubble system are also disclosed.

### CROSS-REFERENCE TO RELATED APPLICATIONS

This application is a continuation of U.S. patent application Ser. No. 15/146,689, filed on 4 May 2016, which in turn claims the benefit of U.S. Provisional Patent Application 62/156,642, filed 4 May 2015, the entireties of which are hereby incorporated by reference.

### FIELD OF THE INVENTION

This disclosure relates to enhanced micro bubble generation, and in particular to devices and methods for generating microbubbles in water or other fluid. Devices and methods according to this disclosure may also introduce nutrients or sanitizing agents into the water or other fluid.

### DESCRIPTION OF THE RELATED ART

Prior art devices for generating microbubbles have drawbacks which hamper their efficiency and impair their practical uses. One known method for producing microbubbles is to electrolyze a liquid between two electrodes, in which the microbubbles are formed at the surface of one of the electrodes by a gas released in the electrolysis reaction. Such electrolysis processes are too costly to produce microbubbles on a large scale and cannot practically be utilized in conjunction with liquid dispensing fittings because of the physical size and configuration of the necessary components. Furthermore, such systems are typically large and require electrical enclosures to house the necessary components.

U.S. Pat. No. 4,556,523 to Lecoffre et al. (“Lecoffre”) discloses a microbubble injector comprising a deflector wall, which radially deflects a flow of water exiting under pressure from an injector hole and saturated with dissolved air, thus producing cavitation at the edges of the injector hole and generating microbubbles of air downstream of the injector hole. Similarly, U.S. Pat. No. 6,293,529 to Chang et al. (“Chang”) discloses a bubble generating apparatus including a hollow shell having a plurality of bottom inlets and a side outlet, a screw rod longitudinally mounted in the shell, and a baffle threaded onto one end of the screw rod and suspended inside the shell above the bottom inlets, the baffle having a plurality of smoothly arched bottom notches for baffling intake flows of high-pressure liquid to produce bubbles. The inventions of Lecoffre and Chang suffer from several disadvantages, however, and could not be used practically or efficiently with typical liquid dispensing fittings, such as hydrotherapy jets, shower heads, and liquid nozzles.

U.S. Patent Application Publication No. 2007/0108640 to Takahashi et al. (“Takahashi”) discloses a microbubble-generating device which incorporates small orifices or screens through which the pressurized liquid and gas must travel. Such features are undesirable because debris and contaminants present in the liquid may clog the orifices/screens, so that at least one of (1) expensive pre-filtering of the liquid prior to reaching the small orifices/screens and (2) repeated and continual cleaning of the orifices/screens would be required to maintain the device in an operational state. Extensive maintenance of this type would place an unnecessary burden on the end user and thus is not practical. The clogging of the small orifices/screens may also be detrimental to a system employing the microbubble-generating device, because the blockage could cause excessive back pressure, resulting in premature wear on system components.

There is thus a long-felt need for a microbubble-generating device that does not utilize orifices or screens which may become clogged, which can produce large quantities of microbubbles while occupying a small physical space and utilize smaller components that are practical to use with liquid dispensing fittings such as hydrotherapy jets, shower heads, liquid nozzles, and bathtub faucets. It is further advantageous for the device to be capable of operating in conjunction with a plumbing fixture having aesthetic or ornamental appeal, e.g. a bathtub, without detracting from the fixture's aesthetic or ornamental appeal.

### BRIEF SUMMARY OF THE INVENTION

The invention provides an enhanced microbubble pump system without orifices or screens that can produce large quantities of microbubbles in a manner that makes the system practical for use with typical liquid dispensing fittings, such as hydrotherapy jets, shower heads, liquid nozzles, and bathtub faucets. A microbubble pump described herein occupies a physical volume 30-40% smaller, is 10-15% quieter in operation, and uses about 35% less electricity than has heretofore been achieved by the solutions of the prior art. The microbubble pump described herein has an improved shaft seal compared to the devices of the prior art, limiting the possibility of water damage to internal components, and retains little or no water. The microbubble pump described herein also produces a superior quantity and quality of microbubbles as compared to prior art solutions and can be produced with materials that are ozone-compatible. Microbubble pump systems, as disclosed herein, require only two interconnections to a bathtub or plumbing, as compared to the four interconnections typical of prior art systems. Significantly, the microbubble pump disclosed herein can be mounted 3-5 inches lower on a bathtub than prior art devices, greatly diminishing the pump's impact on the overall aesthetic appeal of the bathtub.

The present disclosure provides a microbubble system, comprising a gas inlet comprising a first Venturi injector; a pressure vessel, with a microbubble device therein, interconnected to the gas inlet, the pressure vessel configured to receive liquid via a liquid source and mix the liquid with gas received via the gas inlet, the microbubble device configured to generate microbubbles of the gas in the liquid to form a microbubble-entrained liquid; and an outlet interconnected to the pressure vessel, configured to receive the microbubble-entrained liquid from the pressure vessel and dispense the microbubble-entrained liquid.

In example embodiments, the outlet comprises at least one of a microbubble nozzle and a second Venturi injector.

In example embodiments, the microbubble system further comprises a pump interconnected to the pressure vessel and configured to pump the liquid from the liquid source into the pressure vessel. The gas inlet may be located on at least one of an outlet of the pump and an inlet of the pump.

In example embodiments, the gas inlet is located on at least one of an inlet of the pressure vessel and an inlet line feeding the pressure vessel.

In example embodiments, the microbubble system further comprises a third Venturi injector configured to inject a fluid additive either into the liquid before the liquid enters the pressure vessel or into the microbubble-entrained liquid dispensed from the outlet. The fluid additive may comprise at least one of a nutrient and a sanitizing agent.

In example embodiments, the microbubble system is configured to be interconnected to a vessel. The vessel may be selected from the group consisting of a bathtub, a shower, a hot tub, a swimming pool, a plunge pool, a foot bath, a sink, a trough, a wash basin, a washing machine, a dishwasher, an irrigation ditch, a well, and a spray gun.

In example embodiments, the microbubble system further comprises an attachment interconnected to the outlet and configured to receive the microbubble-entrained liquid. The attachment may be selected from the group consisting of a hair brush, an ear/nose/mouth outlet, a faucet outlet, a handheld wand, a basin, a massager, a handheld scrubber, a soaking vessel, a facial cleansing brush, a multi-outlet jet port, a vessel wall-mounting outlet, and a facial outlet device.

The present disclosure also provides a microbubble system, comprising a gas inlet comprising a first Venturi injector; a pressure vessel interconnected to the gas inlet and configured to receive liquid via a liquid source and mix the liquid with gas received via the gas inlet; a microbubble device configured to generate microbubbles of the gas in the liquid to form a microbubble-entrained liquid; and a microbubble nozzle outlet, interconnected to the pressure vessel and configured to receive the microbubble-entrained liquid from the pressure vessel and dispense the microbubble-entrained liquid.

In example embodiments, the microbubble device is housed within the pressure vessel.

In example embodiments, the microbubble system is configured to interconnect to a vessel containing the liquid, wherein the microbubble device is submerged in the liquid within the vessel. The vessel may be selected from the group consisting of a bathtub, a shower, a hot tub, a swimming pool, a plunge pool, a foot bath, a sink, a trough, a wash basin, a washing machine, a dishwasher, an irrigation ditch, a well, and a spray gun

In example embodiments, the microbubble system further comprises a second Venturi injector configured to inject a fluid additive either into the liquid before the liquid enters the pressure vessel or into the microbubble-entrained liquid dispensed from the microbubble nozzle outlet. The fluid additive may comprise at least one of a nutrient and a sanitizing agent.

In example embodiments, the microbubble system further comprises an attachment interconnected to the microbubble nozzle outlet and configured to receive the microbubble-entrained liquid, the attachment selected from the group consisting of a hair brush, an ear/nose/mouth outlet, a faucet outlet, a handheld wand, a basin, a massager, a handheld scrubber, a soaking vessel, a facial cleansing brush, a multi-outlet jet port, a vessel wall-mounting outlet, and a facial outlet device.

The present disclosure further provides a method for forming an enhanced microbubble-entrained liquid, comprising receiving a starting liquid and a gas; mixing the starting liquid with the gas; generating microbubbles of the gas in the starting liquid to form a microbubble-entrained liquid; and injecting a fluid additive into at least one of the starting liquid and the microbubble-entrained liquid.

In example embodiments, the fluid additive comprises at least one of a nutrient and a sanitizing agent.

These and other advantages will be apparent from the disclosure contained herein.

As used herein, “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

It is to be noted that the term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The embodiments and configurations described herein are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is an illustration of a typical fixed microbubble system according to embodiments of the present invention;

FIG. 2 is an illustration of the microbubble system of FIG. 1 interconnected to a vessel;

FIG. 3 is an illustration of a prior-art microbubble pump;

FIG. 4 is an illustration of a pressure vessel with a microbubble device according to embodiments of the present invention;

FIG. 5 is an illustration of a nozzle for use with microbubble devices according to embodiments of the present invention;

FIG. 6 is an illustration of the microbubble device of FIG. 4 removed from the pressure vessel;

FIG. 7 is an illustration of the microbubble device of FIGS. 4 and 6 with a liquid thin film shroud, according to embodiments of the present invention;

FIG. 8 is an illustration of a prior-art pressure vessel;

FIG. 9 is an illustration of a portable microbubble device according to embodiments of the present invention;

FIG. 10 is another illustration of a portable microbubble device according to embodiments of the present invention;

FIG. 11 is an illustration of an attachment to the portable microbubble device according to embodiments of the present invention;

FIG. 12 is an illustration of another attachment to the portable microbubble device according to embodiments of the present invention;

FIG. 13 is an illustration of a faucet outlet to the portable microbubble device according to embodiments of the present invention;

FIG. 14 is an illustration of a wand attachment to the portable microbubble device according to embodiments of the present invention;

FIG. 15 is an illustration of a basin attachment to the portable microbubble device according to embodiments of the present invention;

FIG. 16 is an illustration of a massage attachment to the portable microbubble device according to embodiments of the present invention;

FIG. 17 is an illustration of a scrubber attachment to the portable microbubble device according to embodiments of the present invention;

FIG. 18 is an illustration of a soaking vessel attachment to the portable microbubble device according to embodiments of the present invention;

FIG. 19 is an illustration of a brush attachment to the portable microbubble device according to embodiments of the present invention;

FIG. 20 is an illustration of a multi-outlet attachment to the portable microbubble device according to embodiments of the present invention;

FIG. 21 is an illustration of a single-outlet attachment to the portable microbubble device according to embodiments of the present invention; and

FIG. 22 is an illustration of a facial outlet attachment to the portable microbubble device according to embodiments of the present invention.

### DETAILED DESCRIPTION OF THE INVENTION

Unless defined otherwise, all technical and scientific terms used herein have the same meaning as is commonly understood by one of ordinary skill in the art. All patents, applications, published applications, and other publications to which reference is made herein are incorporated by reference in their entirety. In the event that there is a plurality of definitions for a term herein, the definition provided in the Brief Summary of the Invention prevails unless otherwise stated.

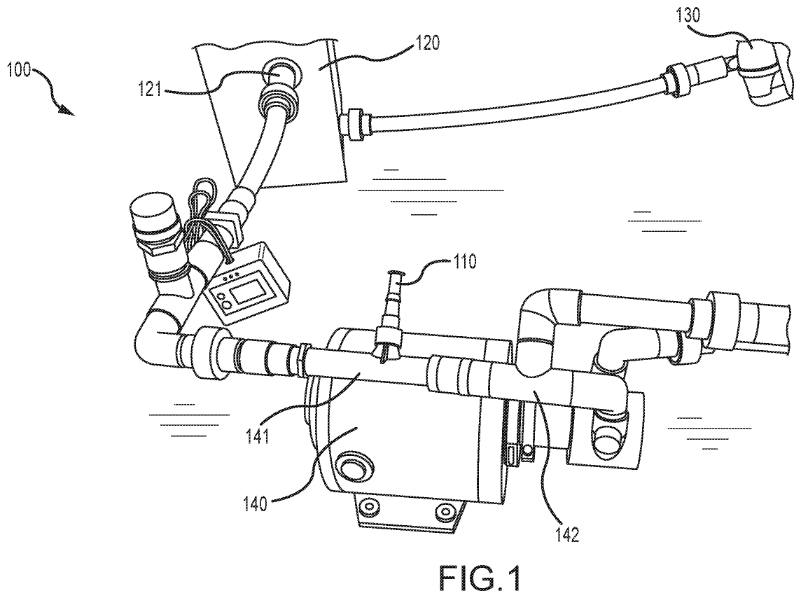

Referring now to FIG. 1, a typical microbubble system 100 according to embodiments of the present invention is illustrated. The system 100 comprises a gas inlet 110 comprising a Venturi injector, a pressure vessel 120 with a microbubble device therein, and a microbubble nozzle and/or Venturi injector outlet 130 interconnected to the pressure vessel 120, and may, as illustrated in FIG. 1, further comprise a pump 140 interconnected to the pressure vessel 120. The gas inlet 110 is preferably located at an outlet 141 of the pump 140, as illustrated in FIG. 1, or on an inlet line feeding the pressure vessel 120, but may be located at an inlet 142 of the pump 140, or at an inlet 121 of the pressure vessel 120, as well. The pressure vessel 120 receives liquid from a liquid source or from a pump 140 and mixes the liquid with gas received via the gas inlet 110. The liquid may be supplied by a domestic pressurized fluid source, alone or in conjunction with a booster pump or a recirculating system powered by a pump. One or more Venturi injectors may inject gases or liquid additives to the liquid prior to the liquid entering the pressure vessel 120. Microbubbles of the gas are generated by the microbubble device within the pressure vessel 120, and the microbubble-entrained liquid then flows to the microbubble outlet nozzle and/or Venturi injector outlet 130, which dispenses the liquid according to a desired use. Venturi injectors may additionally be used in conjunction with the microbubble outlet nozzle 130 to inject additional gases or liquids into the dispensed liquid. In embodiments that do not comprise a pump, the pressure vessel 120 may be interconnected directly to the liquid source.

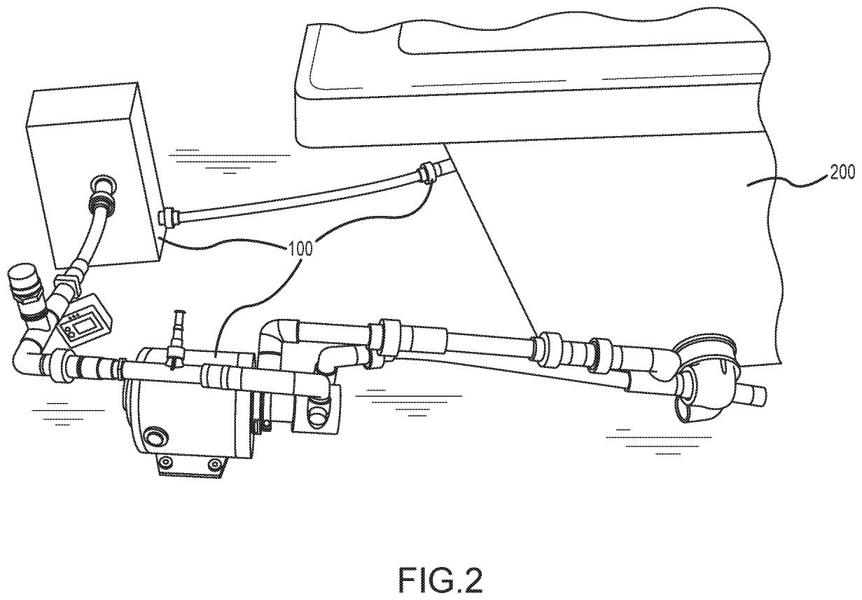

Referring now to FIG. 2, the microbubble system 100 of FIG. 1 is illustrated interconnected to a vessel 200. In this embodiment, the vessel 200 is a bathtub, but other vessels suitable for use with systems of the present invention include, but are not limited to, showers, hot tubs, swimming and plunge pools, foot baths, sinks, troughs, wash basins, washing machines, dishwashers, irrigation ditches, wells, spray guns, and any other vessels used for bathing, hydrotherapy, cleaning or processing food, hydroponic agriculture, application of fertilizer, and the like.

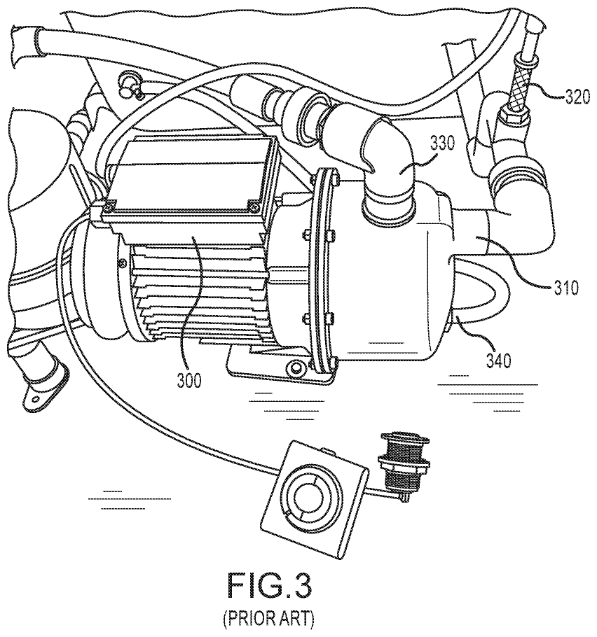

Referring now to FIG. 3, a microbubble pump 300 as known and described in the prior art is illustrated. This pump 300 is a centrifugal pump used for shallow water wells and comprises a liquid inlet 310, a gas inlet 320 on the liquid inlet 310, a prime port (on a back side of the pump, not shown), a liquid outlet 330, and a drain port 340. Because air or other gas is injected to the pump 300 on an inlet, or suction, side of the pump, cavitation may take place within the pump 300 itself, creating unnecessary noise and an increased likelihood of shaft seal failure. The pump 300 is quite large, is not self-priming, and requires four connections to a bathtub or plumbing. Water may be retained within the pump 300, which may lead to the growth of bacteria or molds. The pump 300 has a substantial electricity requirement of ten amps, and must be mounted in a particular direction, high on a bathtub or other plumbing fixture. These and other limitations of the pumps of the prior art are overcome by the microbubble devices and systems illustrated in FIGS. 1, 2, and 4-7.

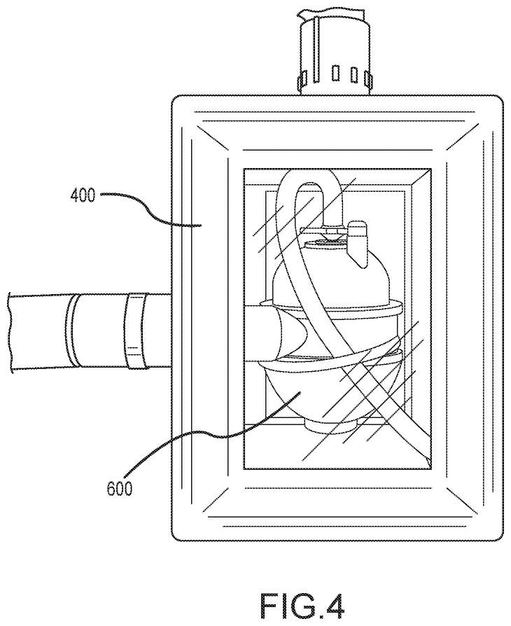

Referring now to FIG. 4, a pressure vessel 400 with a microbubble device 600 according to embodiments of the present invention is illustrated. The pressure vessel 400 may have a shape different from that shown in FIG. 4.

Referring now to FIG. 5, a nozzle 500 for use with microbubble devices according to embodiments of the present invention is illustrated. The nozzle 500 is adapted to be installed on a plumbing line and may serve as the microbubble outlet nozzle 130 illustrated in FIG. 1. The nozzle 500 is used to mechanically stimulate the microbubbles, allowing a microbubble-entrained liquid to contain higher concentrations of oxygen, ozone, and nutrients. One or more Venturi injectors, with or without regulation devices, may be used in conjunction with the nozzle 500 to inject nutrients or sanitizing agents into the microbubble-entrained liquid.

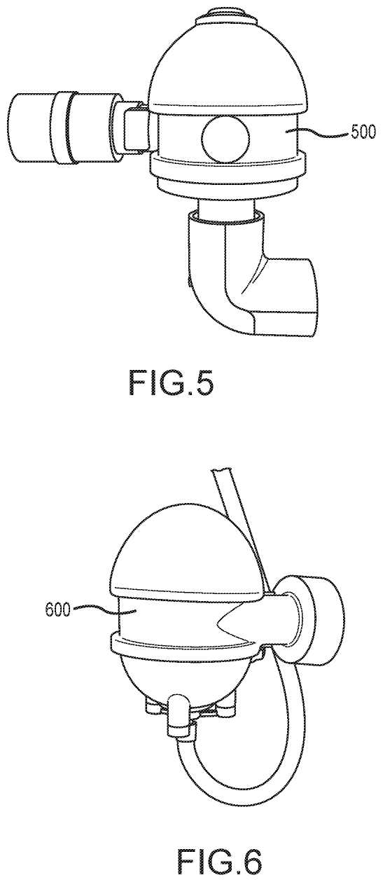

Referring now to FIG. 6, a microbubble device 600 according to embodiments of the present invention is illustrated. In operation, the microbubble device 600 may be interconnected to or housed within a pressure vessel 400, as illustrated in FIG. 4, or may be installed and submerged directly into a vessel of fluid.

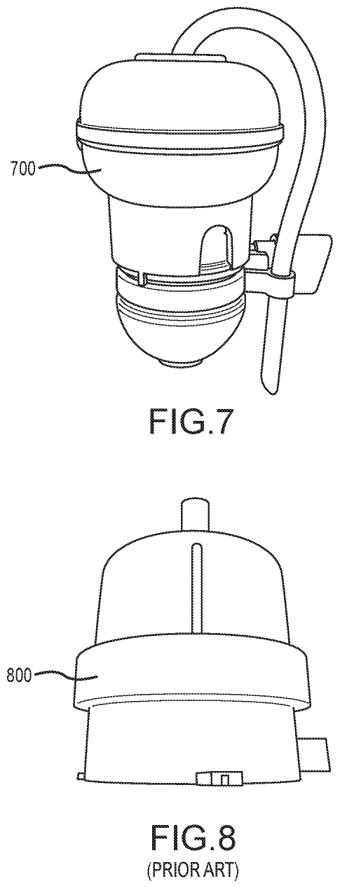

Referring now to FIG. 7, the microbubble device 600 of FIGS. 4 and 6 is provided with a liquid thin film (LTF) shroud 700. The LTF shroud 700 protects any inner functional components and improves the aesthetics of the microbubble device 600. It is to be understood that the microbubble device 600 of FIG. 6 may be provided with or without the LTF shroud 700.

Referring now to FIG. 8, a pressure vessel 800 as known and described in the prior art, and suitable for use with microbubble devices of the prior art, is illustrated. The pressure vessel 800 of FIG. 8 is noticeably larger than the pressure vessel 400 of the present invention as illustrated in FIG. 4.

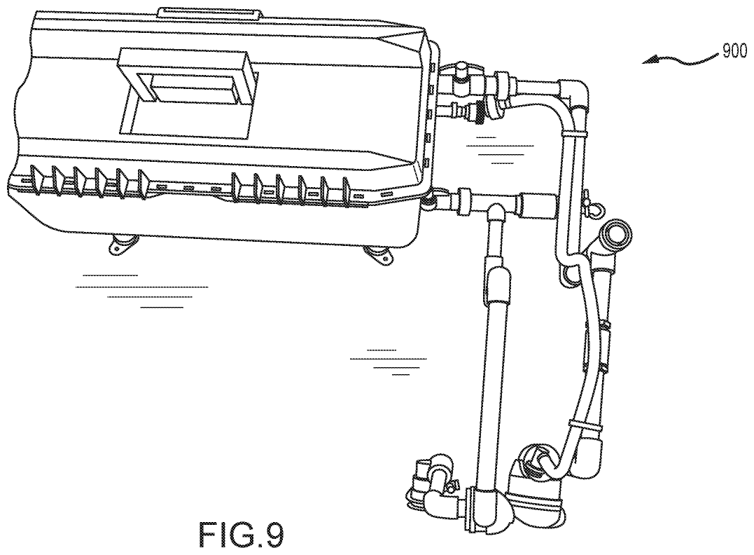

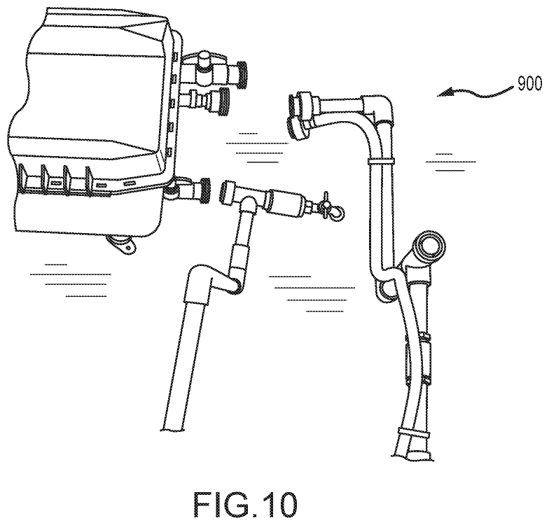

Referring now to FIGS. 9 and 10, a portable microbubble device 900 according to embodiments of the present invention is illustrated. The portable microbubble device 900 does not permanently interconnect to a vessel's plumbing inputs but instead can collect liquid from the previously filled vessel or from a domestic fluid source, produces microbubbles in the liquid and/or enhances the liquid with nutrients or sanitizing agents by way of a Venturi injector, and then dispenses the microbubble-entrained and/or enhanced liquid according to a desired application.

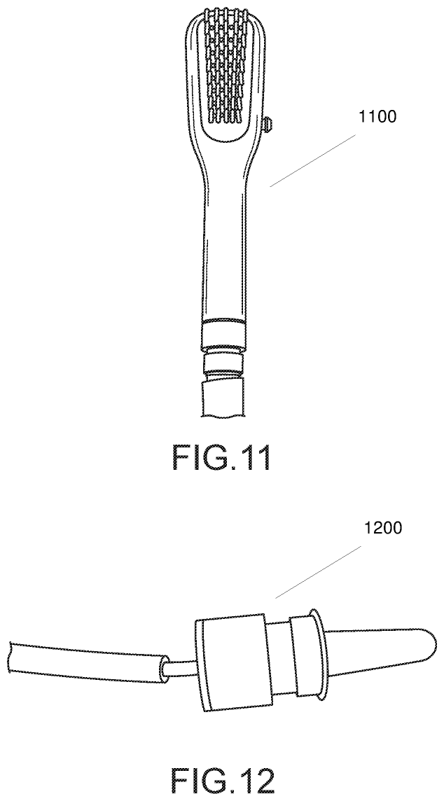

Referring now to FIGS. 11-22, various outlets and attachments that may be suitable for particular applications of the present invention are illustrated. FIG. 11 illustrates a hair brush 1100 comprising ports through which oxygenated or ozonated water may be injected, as may be suitable, for example, for use in pet grooming or human hair treatment.

FIG. 12 illustrates an ear/nose/mouth outlet 1200 that may dispense oxygenated or ozonated water, whereby the oxygenated or ozonated water may provide improved cleaning or therapeutic effects due to the tendency of oxygen or ozone bubbles to cling to the surfaces of a user's ear, nose, mouth, etc.

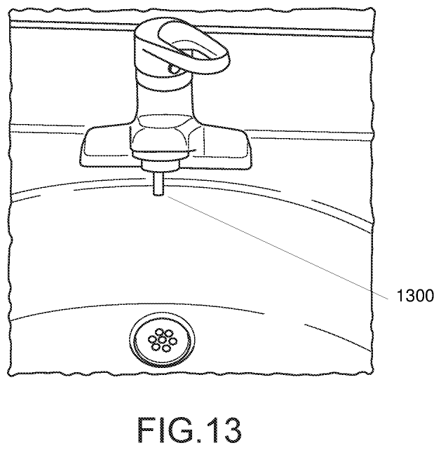

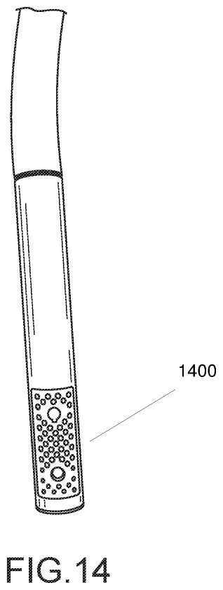

FIG. 13 illustrates a faucet outlet 1300, which may be suitable, for example, for dispensing microbubble-entrained water from a household faucet. FIG. 14 illustrates a handheld wand 1400, which may provide microbubble-entrained water as may be suitable, for example, for washing or treating the hair or skin of a user.

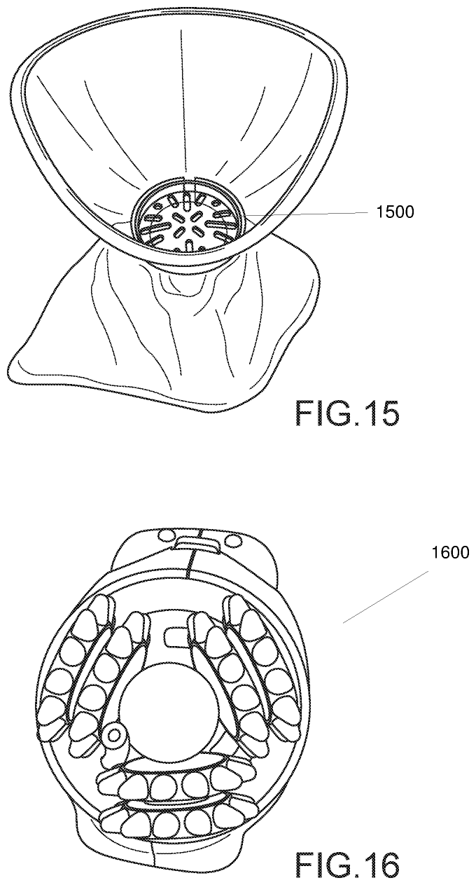

FIG. 15 illustrates a basin 1500 suitable for containing and holding oxygenated water during hair or skin treatments and can thus function as, by way of non-limiting example, a hair washing basin, a facial washing basin, a pedicure soak basin, or a shower cap.

FIG. 16 illustrates a trigger point soft tissue muscle massager 1600, which may be injected with oxygenated water and either dispense the oxygenated water for therapeutic purposes or utilize the oxygenated water as a motive pressure source for driving mechanical massaging elements.

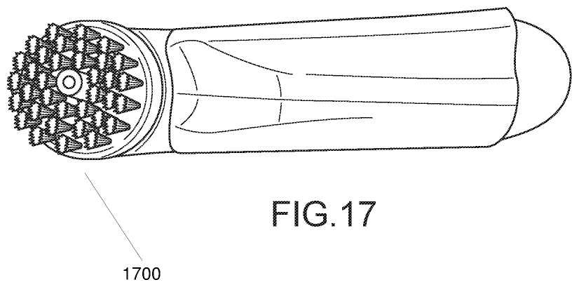

FIG. 17 illustrates a handheld scrubber 1700 powered by injected oxygenated water, as may be suitable, for example, for mounting to a kitchen sink for cleaning fruits and vegetables, or for cleaning the skin of a user, such as during a pedicure.

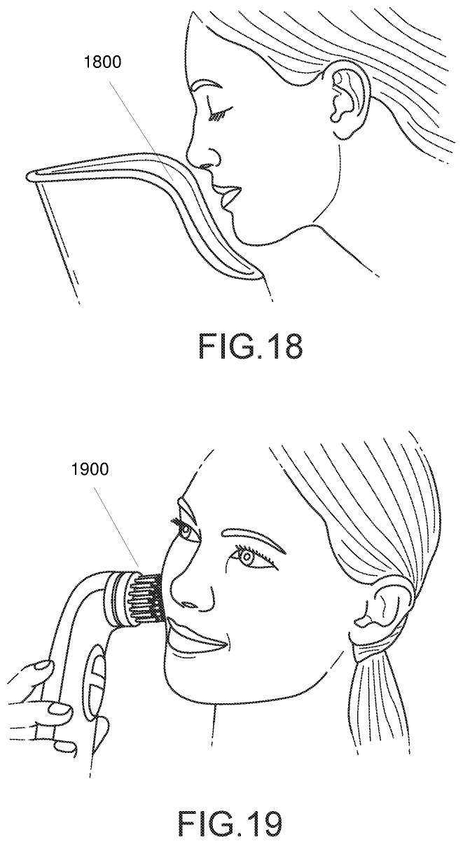

FIG. 18 illustrates a soaking vessel 1800 that may contain oxygen- or sanitizing agent-injected water and may be utilized by a user to, for example, clean, disinfect, or treat skin pores and hair follicles.

FIG. 19 illustrates a facial cleansing brush 1900 that may dispense oxygen- or sanitizing agent-injected water and may be utilized by a user to, for example, clean, disinfect, or treat pores of the skin on the user's face.

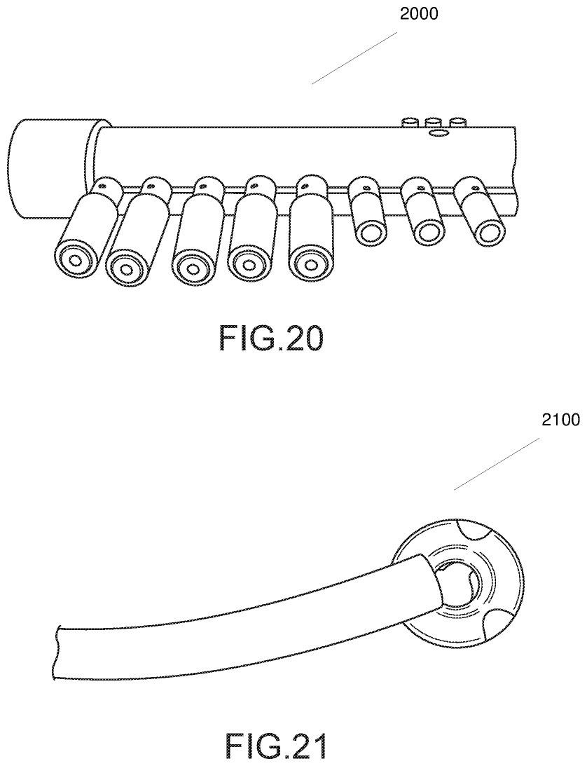

FIG. 20 illustrates a multi-outlet jet port 2000 that may be mounted, for example, on a wall of a vessel or in conjunction with a carpet cleaning device to dispense microbubble-entrained or sanitizing agent-injected water.

FIG. 21 illustrates a standard port outlet 2100 for mounting in the wall of a vessel, the standard port outlet 2100 optionally comprising a hose or other handheld attachments.

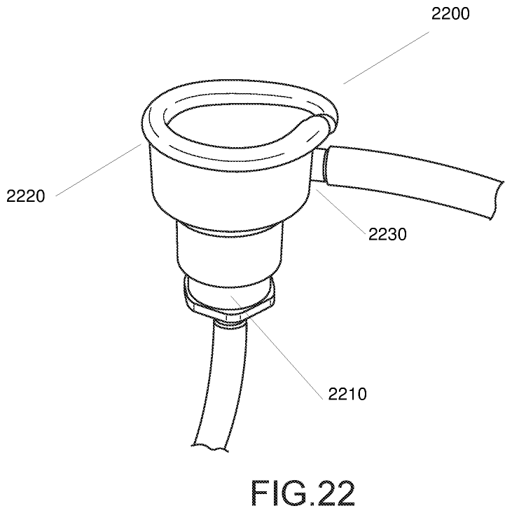

FIG. 22 illustrates a facial outlet device 2200, comprising an inlet 2210, a sealing gasket 2220, and an outlet 2230, as may be suitable, for example, for treating target areas such as liver spots on a user's face, scalp, etc. with oxygenated water.

The invention illustratively disclosed herein suitably may be practiced in the absence of any element which is not specifically disclosed herein. It is apparent to those skilled in the art, however, that many changes, variations, modifications, other uses, and applications of the invention are possible, and also changes, variations, modifications, other uses, and applications which do not depart from the spirit and scope of the invention are deemed to be covered by the invention.

The foregoing discussion of the invention has been presented for purposes of illustration and description. The foregoing is not intended to limit the invention to the form or forms disclosed herein. In the foregoing Detailed Description of the Invention, for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the invention requires more features than are expressly recited. Rather, inventive aspects lie in less than all features of a single foregoing disclosed embodiment.

Moreover, though the description of the invention has included description of one or more embodiments and certain variations and modifications, other variations, combinations, and modifications are within the scope of the invention, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those described, whether or not such alternate, interchangeable, and/or equivalent structures, functions, ranges, or steps are disclosed herein, and without intending to publicly dedicate any patentable subject matter.

What is claimed is:

1. A microbubble system, comprising:
a gas inlet comprising a first Venturi injector;
a pressure vessel, with a microbubble device therein, interconnected to the gas inlet, the pressure vessel configured to receive liquid via a liquid source and mix the liquid with gas received via the gas inlet, the microbubble device configured to generate microbubbles of the gas in the liquid to form a microbubble-entrained liquid; and
an outlet interconnected to the pressure vessel, configured to receive the microbubble-entrained liquid from the pressure vessel and dispense the microbubble-entrained liquid.

2. The microbubble system of claim 1, wherein the outlet comprises at least one of a microbubble nozzle and a second Venturi injector.

3. The microbubble system of claim 1, further comprising a pump interconnected to the pressure vessel and configured to pump the liquid from the liquid source into the pressure vessel.

4. The microbubble system of claim 3, wherein the gas inlet is located on at least one of an outlet of the pump and an inlet of the pump.

5. The microbubble system of claim 1, wherein the gas inlet is located on at least one of an inlet of the pressure vessel and an inlet line feeding the pressure vessel.

6. The microbubble system of claim 1, further comprising a third Venturi injector configured to inject a fluid additive either into the liquid before the liquid enters the pressure vessel or into the microbubble-entrained liquid dispensed from the outlet.

7. The microbubble system of claim 6, wherein the fluid additive comprises at least one of a nutrient and a sanitizing agent.

8. The microbubble system of claim 1, configured to be interconnected to a vessel.

9. The microbubble system of claim 8, wherein the vessel is selected from the group consisting of a bathtub, a shower, a hot tub, a swimming pool, a plunge pool, a foot bath, a sink, a trough, a wash basin, a washing machine, a dishwasher, an irrigation ditch, a well, and a spray gun.

10. The microbubble system of claim 1, further comprising an attachment interconnected to the outlet and configured to receive the microbubble-entrained liquid.

11. The microbubble system of claim 10, wherein the attachment is selected from the group consisting of a hair brush, an ear/nose/mouth outlet, a faucet outlet, a handheld wand, a basin, a massager, a handheld scrubber, a soaking vessel, a facial cleansing brush, a multi-outlet jet port, a vessel wall-mounting outlet, and a facial outlet device.

12. A microbubble system, comprising:
a gas inlet comprising a first Venturi injector;
a pressure vessel interconnected to the gas inlet and configured to receive liquid via a liquid source and mix the liquid with gas received via the gas inlet;
a microbubble device configured to generate microbubbles of the gas in the liquid to form a microbubble-entrained liquid; and
a microbubble nozzle outlet, interconnected to the pressure vessel and configured to receive the microbubble-entrained liquid from the pressure vessel and dispense the microbubble-entrained liquid.

13. The microbubble system of claim 12, wherein the microbubble device is housed within the pressure vessel.

14. The microbubble system of claim 12, configured to interconnect to a vessel containing the liquid, wherein the microbubble device is submerged in the liquid within the vessel.

15. The microbubble system of claim 14, wherein the vessel is selected from the group consisting of a bathtub, a shower, a hot tub, a swimming pool, a plunge pool, a foot bath, a sink, a trough, a wash basin, a washing machine, a dishwasher, an irrigation ditch, a well, and a spray gun.

16. The microbubble system of claim 12, further comprising a second Venturi injector configured to inject a fluid additive either into the liquid before the liquid enters the pressure vessel or into the microbubble-entrained liquid dispensed from the microbubble nozzle outlet.

17. The microbubble system of claim 16, wherein the fluid additive comprises at least one of a nutrient and a sanitizing agent.

18. The microbubble system of claim 12, further comprising an attachment interconnected to the microbubble nozzle outlet and configured to receive the microbubble-entrained liquid, the attachment selected from the group consisting of a hair brush, an ear/nose/mouth outlet, a faucet outlet, a handheld wand, a basin, a massager, a handheld scrubber, a soaking vessel, a facial cleansing brush, a multi-outlet jet port, a vessel wall-mounting outlet, and a facial outlet device.

19. A method for forming an enhanced microbubble-entrained liquid, comprising:
receiving a starting liquid and a gas;
mixing the starting liquid with the gas;
generating microbubbles of the gas in the starting liquid to form a microbubble-entrained liquid; and
injecting a fluid additive into at least one of the starting liquid and the microbubble-entrained liquid.

20. The method of claim 19, wherein the fluid additive comprises at least one of a nutrient and a sanitizing agent.
